(19) United States
(12) Patent Application Publication
(10) Pub. No.: US 2004/0034541 A1
(43) Pub. Date: Feb. 19, 2004

(54) Client devices, processor-usable media, data signals embodied in a transmission medium and processor implemented methods

(76) Inventor: Alipio Caban, Arecibo, PR (US)

Correspondence Address: HEWLETT-PACKARD COMPANY, Intellectual Property Administration, P.O. Box 272400, Fort Collins, CO, 80527-2400, US

(21) Appl. No.: 10/222,414

(22) Filed: Aug. 16, 2002

(51) Int. Cl. G06F 17/60

(52) U.S. Cl. 705/1; 715/517; 715/513

(57) ABSTRACT

Client devices, processor-usable media, data signals embodied in a transmission medium and processor implemented methods are described. According to one aspect, a client device includes an interface adapted to communicate with a computer network including a plurality of web servers hosting a plurality of respective web sites and to receive web page data for a plurality of web pages from the web servers, a display device configured to depict visually perceptible images and processing circuitry coupled with the display device and configured to control the display device to depict the web pages responsive to the received web page data and to depict a visual organizational representation of the web pages depicted using the display device, wherein the visual organizational representation comprises a plurality of first identifiers for selected ones of the web pages of one of the web sites and a plurality of second identifiers for selected others of the web pages of the one web site, and the first identifiers are depicted according to a first organizational scheme and the second identifiers are depicted according to a second organizational scheme visually distinguishable from the first identifiers of the first organizational scheme and one of the second identifiers is visually associated with one of the first identifiers.

### FIELD OF THE INVENTION

The invention relates to client devices, processor-usable media, data signals embodied in a transmission medium and processor implemented methods.

### BACKGROUND OF THE INVENTION

The popularity of the Internet in entertainment, research, education, marketing, sales and other areas continues to expand. The World Wide Web (www) displays information communicated via the Internet using graphics and links which enable web users to travel quickly from one web server to another. A user can access web pages using different links while navigating the World Wide Web. Client or web browsers, such as Netscape Communicator™ available from Netscape Communications Corporation and Internet Explorer™ available from Microsoft Corporation, are executed upon client computers and assist with navigation of the Internet and web enabling the display of pages using the client computers.

FIG. 1 depicts an exemplary screen display of a “history” functionality of Internet Explorer. The screen display of FIG. 1 includes a plurality of folders 10 corresponding to respective days or other periods of time and a plurality of web addresses or uniform resource locators (URLs) 12 corresponding to web pages of the Internet which have been downloaded and displayed using the web browser upon a client computer. FIG. 1 illustrates a sequential listing of web page URLs accessed without showing the logical path taken.

FIG. 2 depicts an exemplary screen display of a “favorite” functionality of Internet Explorer. The favorite functionality of Internet Explorer depicts folders 10 which can be defined by a user for convenience, to correspond to a common subject matter, etc. Folder 11 may be referred to as a sub-folder or sub-directory of folder 13. Icon 14 is found within folder 11 while folder 11 and icons 16 are found within folder 13. The depicted icons 14, 16 may correspond to web addresses or URLs with no association between the icons 14 and 16.

Referring to FIG. 3, an exemplary screen display of Windows Explorer of a Windows XP operating system available from Microsoft Corporation is shown. Windows Explorer is a file manager for depicting organization of folders 10 of one or more mass storage device of an associated computer in a directory structure.

As described below, aspects of the present invention provide improved methods and structural arrangements for accessing and downloading information from a network, such as the Internet.

### DESCRIPTION OF THE DRAWINGS

FIG. 1 is an illustrative representation of a screen display of a history functionality of Internet Explorer.

FIG. 2 is an illustrative representation of a screen display of a favorite functionality of Internet Explorer.

FIG. 3 is an illustrative representation of a screen display of Windows Explorer.

FIG. 4 is a functional block diagram of an exemplary computer network.

FIG. 5 is an illustrative representation of an exemplary screen display generated using a client device of the computer network.

FIG. 6 is an illustrative representation showing additional details of the exemplary screen display of FIG. 5.

FIG. 7 is a flow chart depicting an exemplary methodology for generating the screen display of FIG. 6.

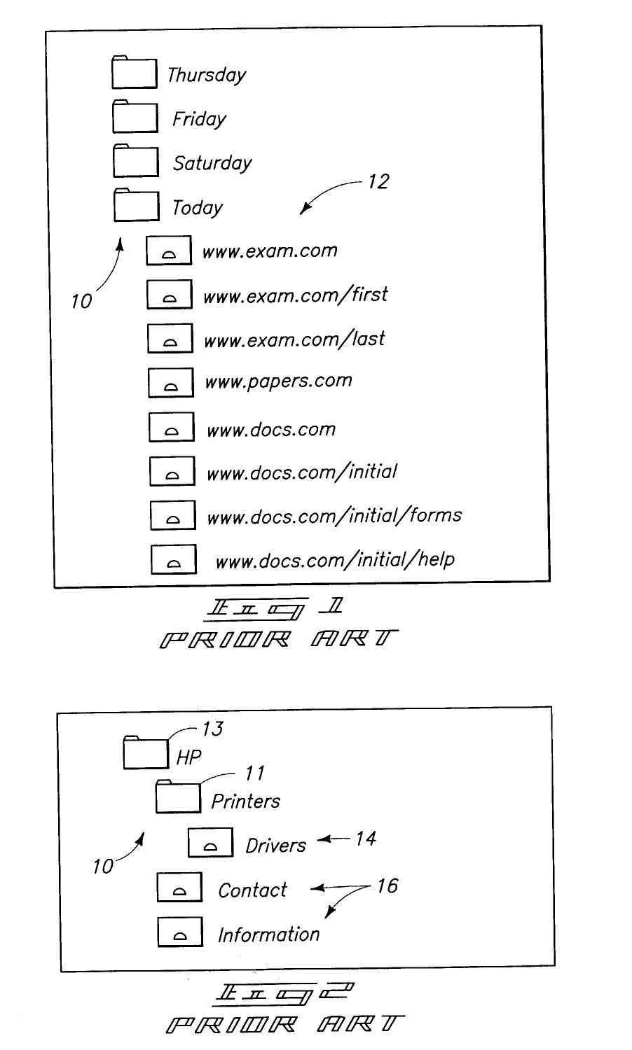

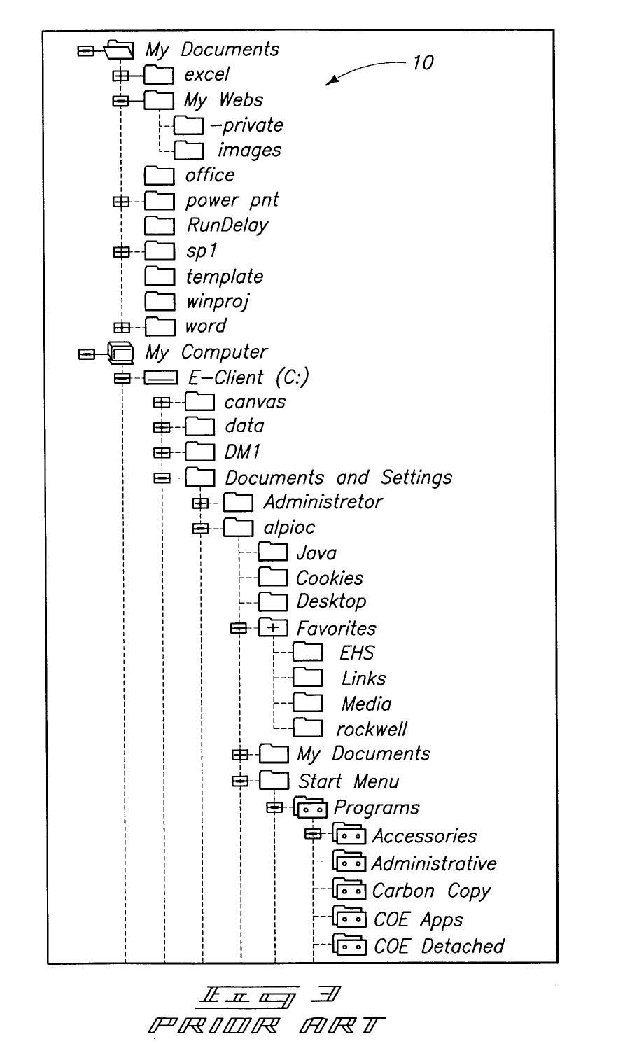

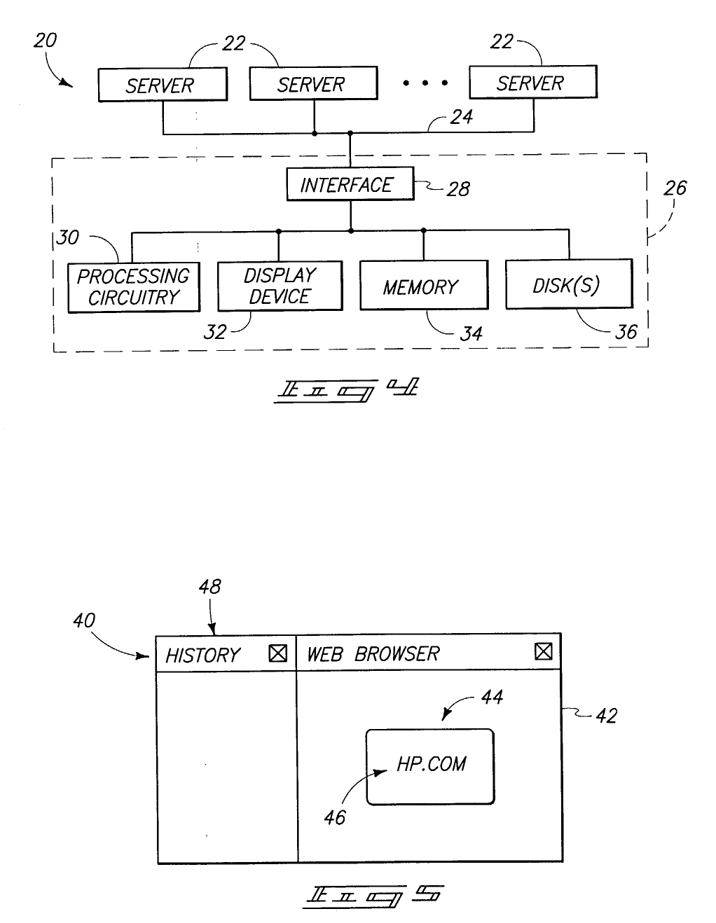

### DETAILED DESCRIPTION OF THE INVENTION

According to one aspect, a client device comprises an interface adapted to communicate with a computer network including a plurality of web servers hosting a plurality of respective web sites and to receive web page data for a plurality of web pages from the web servers, a display device configured to depict visually perceptible images and processing circuitry coupled with the display device and configured to control the display device to depict the web pages responsive to the received web page data and to depict a visual organizational representation of the web pages depicted using the display device, wherein the visual organizational representation comprises a plurality of first identifiers for selected ones of the web pages of one of the web sites and a plurality of second identifiers for selected others of the web pages of the one web site, and the first identifiers are depicted according to a first organizational scheme and the second identifiers are depicted according to a second organizational scheme visually distinguishable from the first identifiers of the first organizational scheme and one of the second identifiers is visually associated with one of the first identifiers.

According to another aspect of the invention, a processor-usable medium comprises processor-usable code configured to cause a processor to control a display of a plurality of web pages of a common web site and including a first type of the web pages and a second type of the web pages different than the first type of the web pages, processor-usable code configured to cause a processor to control a display of a plurality of first identifiers corresponding to the first type of the web pages, processor-usable code configured to cause a processor to control a display of a plurality of second identifiers corresponding to the second type of the web pages and processor-usable code configured to cause a processor to control a display of a visual association of one of the second identifiers with one of the first identifiers.

According to an additional aspect of the invention, a processor-usable medium comprises processor-usable code configured to cause a processor to control a display of a plurality of web pages of a common web site and including a first type of the web pages and a second type of the web pages different than the first type of the web pages, processor-usable code configured to cause a processor to control a display of a history including a plurality of first identifiers corresponding to the first type of the web pages and according to a first organizational scheme and processor-usable code configured to cause a processor to control a display of the history including a plurality of second identifiers corresponding to the second type of the web pages and according to a second organizational scheme visually distinguishable from the first identifiers displayed according to the first organizational scheme.

According to an additional aspect of the invention, a data signal embodied in a transmission medium comprises processor-usable code configured to cause a processor to control a display of a plurality of web pages of a common web site and including a first type of the web pages and a second type of the web pages different than the first type of the web pages, processor-usable code configured to cause a processor to control a display of a plurality of first identifiers corresponding to the first type of the web pages, processor-usable code configured to cause a processor to control a display of a plurality of second identifiers corresponding to the second type of the web pages and processor-usable code configured to cause a processor to control a display of a visual association of one of the second identifiers with one of the first identifiers.

According to yet another aspect of the invention, a processor-implemented method of displaying a history of web pages depicted using a web browser comprises providing web page data for a plurality of web pages of a common web site, the web pages including a first type of web pages and a second type of web pages different than the first type of the web pages, depicting the first type and the second type of web pages of the common web site using a web browser, depicting a plurality of first identifiers corresponding to the first type of the web pages within a history of the web browser, depicting a plurality of second identifiers corresponding to the second type of the web pages within a history of the web browser and visually associating one of the second identifiers with one of the first identifiers.

Referring to FIG. 4, an exemplary computer network is depicted with respect to a reference numeral 20. The depicted network 20 includes a plurality of servers 22, a communication medium 24, and a client device 26. The configuration of FIG. 4 is exemplary to illustrate aspects of the invention and in typical embodiments of computer network 20, a plurality of client devices 26 are provided coupled with the communication medium 24.

Servers 22 are arranged to serve up data files responsive to requests from client device 26 in one embodiment. In configurations wherein computer network 20 is coupled with the Internet, servers 22 may be referred to as internet servers and be configured, for example, as web servers arranged to serve up HyperText Markup Language (HTML) files, such as World Wide Web pages (web pages), responsive to requests from web browsers executed on one or more client device 26.

Communication medium 24 includes an appropriate medium for communicating requests and data files between servers 22 and client device 26. Communication medium 24 may be configured to implement communications with servers 22 and client device 26 using appropriate arrangements including, for example, Ethernet, serial, etc. Communication medium 24 may be arranged to implement communications according to a HyperText Transfer Protocol (HTTP) and a Transmission Control Protocol/Internet Protocol (TCP/IP) networking protocol between devices 22 and client device 26. Communications according to other protocols may be utilized.

Client device 26 may be implemented as a computer device (e.g., personal computer (PC), work station, personal digital assistant (PDA), server, main frame, etc.), non-PC device (e.g., Web Access device, games running programs from the Internet, etc.) or other appropriate device capable of running a client browser, such as a web browser including Netscape Communicator or Internet Explorer or other browser. Client device 26 is arranged to communicate with communication medium 24. For example, in the depicted exemplary configuration, client device 26 is implemented as a personal computer and includes an interface 28, processing circuitry 30, a display device 32, a memory 34 and one or more disk drive 36.

Interface 28 may be implemented as a network interface card (NIC), modem, or any other appropriate device configured to provide input/output communications with respect to communication medium 24.

Processing circuitry 30 may be embodied as a processor arranged to execute instructions, such as executable code (also referred to as processor-usable code), stored within memory 34, stored upon one or more disk 36, received from a server 22, or provided from another source. Processing circuitry 30 may be implemented as a Pentium™ processor available from Intel Corporation, a Power PC™ processor from Motorola, Inc., or an Athlon™ processor from Advanced Micro Devices, Inc. in exemplary configurations.

Display device 32 can include a video card and a computer monitor arranged to depict visually perceptible images responsive to control from processing circuitry 30.

Memory 34 may include read only memory (ROM) and random access memory (RAM) arranged to store data and executable code usable by processing circuitry 30.

Disk(s) 36 includes one or more hard drive, floppy disk drive, ZIP drive, CD-ROM drive, etc. arranged to store data and executable code usable by processing circuitry 30. For example, executable code of a client browser may be stored upon disk(s) 36.

Processing circuitry 30 is arranged to access data, such as HTML files, from one or more server 22. Processing circuitry 30 is arranged to formulate requests which are communicated using interface 28 and communication medium 24 to a respective server 22 as identified by an appropriate address, such as an Internet Protocol (IP) address. In one embodiment, processing circuitry 30 executes code of a client browser, such as a web browser, to access the data.

Individual servers 22 may include a plurality of HTML files, such web pages, arranged for example in one or more directory. Servers 22 may host web sites including a plurality of related web pages including respective home pages.

Processing circuitry 30 of client device 26 is arranged to submit requests to servers 22 and appropriate servers 22 are arranged to communicate data to client device 26 responsive to the requests. In one embodiment, the communicated data from servers 22 may include HTML data and may be referred to as web page data. HTML data may include links which a user of client device 26 uses to link to another URL, including for example, another portion of a web page, another web page of the same web site, or another web site hosted by the same or another server 22. Processing circuitry 30 is arranged to control display device 32 to depict visual images responsive to data received from servers 22. For example, processing circuitry 30 may control display device 32 to depict web pages responsive to received HTML data from servers 22.

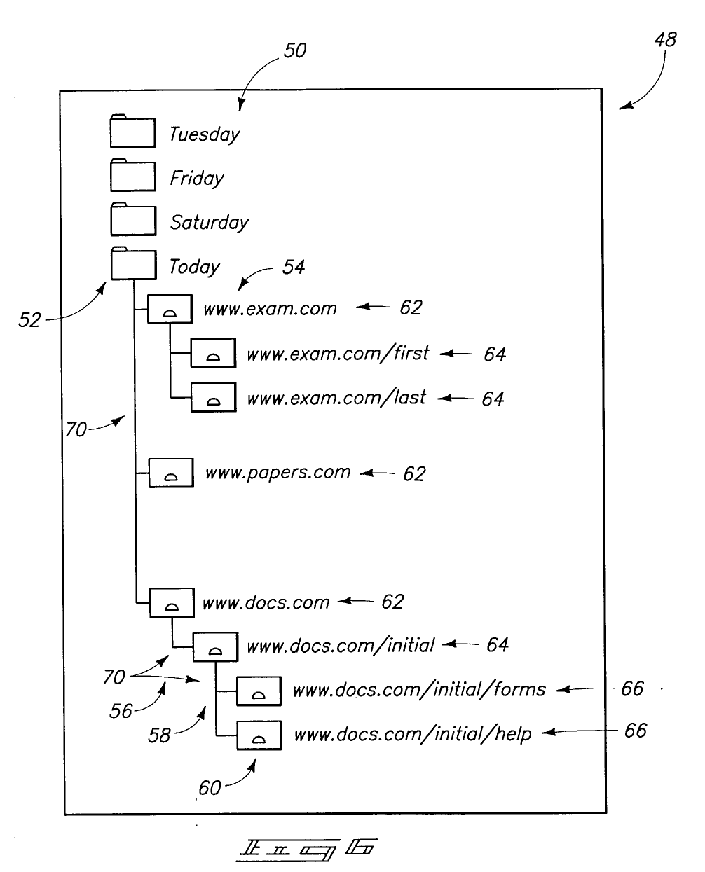

Referring to FIG. 5, an exemplary visually perceptible image depicted using display device 32 is shown. The exemplary image is a screen display 40 generated responsive to data received from one or more server 22 and responsive to control of processing circuitry 30. Screen display 40 includes a window 42 depicted responsive to execution of executable code of a web browser using processing circuitry 30.

Processing circuitry 30 is arranged to generate an exemplary image 44 within window 42 and responsive to data received from one or more server 22. The exemplary illustrated image 44 includes a link 46, which if selected by a user, sends a request from client device 26 to an appropriate server 22 identified by link 46 (i.e., corresponding to hp.com in the illustrated exemplary configuration). The identified server 22 sends data to client device 26 responsive to receiving the request and client device 26 may depict the data using display device 32.

The exemplary window 42 of FIG. 5 also includes a history portion 48 which is arranged to illustrate identifiers of data (e.g., web pages) which have been depicted using display device 32 during a predefined period of time.

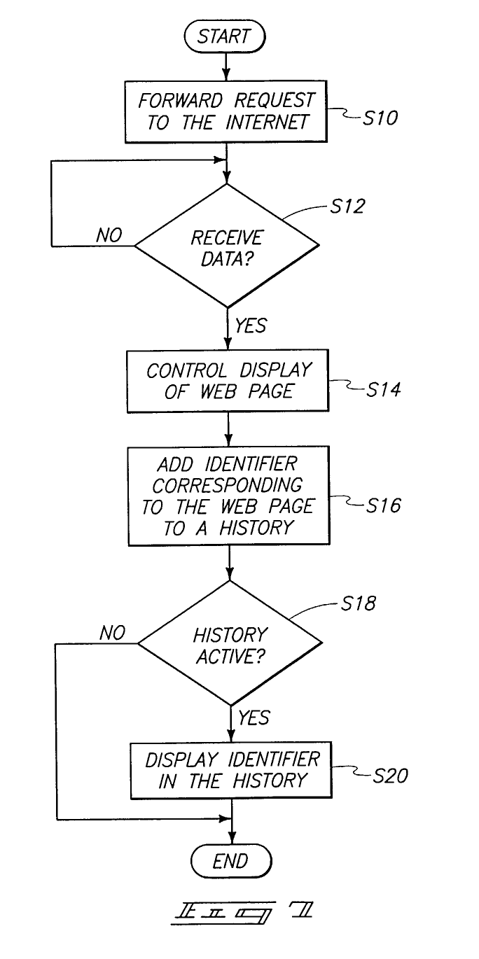

Referring to FIG. 6, details of an exemplary history 48 are described. History 48 includes a visual organizational representation 50 of HTML data (e.g., web pages) that has been depicted using display device 32. In the illustrated exemplary arrangement, visual organizational representation 50 includes a plurality of identifiers 52 corresponding to predefined moments in time. For example, in the illustrated configuration of FIG. 6, identifiers 52 include folders corresponding to respective days. In other arrangements, identifiers 52 may correspond to weeks, months or other desired predetermined amounts of time.

Individual identifiers 52 may be clicked upon using a user interface, such as a mouse or pointer (not shown), of client device 26 to depict further details of the selected identifier 52. In the arrangement of FIG. 6, the identifier 52 associated with “today” has been selected to depict additional details of HTML data received from servers 22 and depicted using display device 32 during the current day.

In the illustrated exemplary configuration, details of the HTML data depicted using display device 32 are illustrated in a navigation tree 54. Other arrangements for depicting the details are possible. The navigation tree 54 of the exemplary illustrated visual organizational representation 50 includes a plurality of identifiers of respective web pages which have been depicted using display device 32. As illustrated, identifiers of a plurality of web pages (e.g., www.exam.com, www.exam.com/first, www.exam.com/last) of a common web site (e.g., www.exam.com) may be depicted using display device 32 and responsive to control from processing circuitry 30.

The identifiers of the web pages are arranged according to a plurality of organizational schemes and corresponding to the types of respective web pages in one exemplary arrangement. For example, the depicted visual organizational representation 50 includes a first organizational scheme 56 having one or more first identifier 62, a second organizational scheme having one or more second identifier 64, and a third organizational scheme 60 having one or more third identifier 66. Other representations 50 may include more or less organizational schemes corresponding to data received from servers 22 and the types of web pages displayed.

In the illustrated exemplary configuration, identifiers 62, 64, 66 correspond to HTML data received from one or more server 22 and which has been depicted using display device 32 during the selected period of time corresponding to the selected identifier 52. Identifiers 62, 64, 66 can include respective icons and URLs which identify respective HTML or web page data. Identifiers 62, 64, 66 may comprise links which a user may select (e.g., using a mouse) to access the respective HTML or web page data of the identifiers 62, 64, 66. The depicted identifiers 62, 64, 66 are exemplary and other arrangements are possible including for example, Internet protocol (IP) addresses, user specified identifiers, or other appropriate identifiers of data.

Identifiers 62, 64, 66 may correspond to respective different types of web pages or other data depicted using display device 32. For example, identifier 62 may correspond to a first type of web pages, second identifier 64 may correspond to a second type of web pages and third identifiers 66 may correspond to a third type of web pages. First identifiers 62 correspond to parent web pages, second identifiers 64 correspond to child web pages, and third identifiers 66 correspond to grandchild web pages in one exemplary organizational embodiment. Grandchild web pages may be accessed using a link within a child web page which in turn may be accessed using a link within a parent web page. Parent web pages may also be referred to as root web pages, child web pages may be referred to as branch web pages, and grandchild web pages may also be referred to as leaf web pages.

According to additional aspects of the invention, an identifier may be visually associated with another identifier of the same organizational scheme and/or another identifier of another organizational scheme. The visual association may be represented by one or more path connector 70 associating appropriate identifiers 62, 64, 66 with one another and/or with one of identifiers 52. Accordingly, a connector 70 intermediate the identifier 62 including www.exam.com and the identifier 64 including www.exam.com/first represents a parent/child relationship of such identifiers (and the respective web pages) and illustrates paths to the respective web pages.

The identifiers 62, 64, 66 of one respective organizational scheme 56, 58, 60 are visually distinguishable from identifiers of other organizational schemes according to one exemplary visual organizational representation 50. For example, in the illustrated representation 50, the respective organizational schemes 56, 58, 60 depict the respective identifiers 62, 64, 66 in different spatial locations within history 48 of screen display 40. In the depicted example, the organizational schemes 56, 58, 60 having different spatial locations comprise different columns of respective identifiers 62, 64, 66 in a horizontal direction. Identifiers 66 of organizational scheme 60 are indented with respect to identifiers 64 of organizational scheme 58 which in turn are indented with respect to identifiers 62 of organizational scheme 56. Additional organizational schemes may also be provided including identifiers indented with respect to identifiers of scheme 60.

In one operational arrangement, history 48 including identifiers 62, 64, 66 is automatically generated responsive to received data from servers 22 and without user input. For example, the user may submit a request to one or more server 22 using client device 26, and the reception of data responsive to the request may automatically initiate generation of history 48 including automatic generation of an identifier for the received data. Accordingly, history 48 is automatically generated in one aspect. According to other aspects, affirmative user input may be required to generate data within history 48. In addition, history 48 may be selectively activated (i.e., displayed) or deactivated (i.e., hidden) responsive to control by a user.

According to one exemplary configuration, visual organizational representation 50 displays different identifiers 62, 64, 66 which may be selected (e.g., using a mouse) to lead a user to respective web pages in an indented format. The depicted configuration of representation 50 clearly shows paths followed to reach particular web pages. Further, the visual organizational representation 50 allows a user to go directly to any web site in history 48 by selecting the respective identifier 62, 64, 66 and without using sequential “back” and “forward” buttons (not shown), for example, as presented with Internet Explorer. “Back” and “forward” functionality or similar features may be provided in some embodiments in addition to the provided visual organizational representation 50 providing increased flexibility.

According to exemplary aspects, a user may access a plurality of web pages using respective links. The visual organizational representation 50 shows paths from initially accessed web pages (e.g., parent pages) and indents subsequently accessed web pages (e.g., child pages, grandchild pages) entered through corresponding links of previous web pages. A user can change the path to previously accessed pages by directly selecting a desired identifier without having to use “back” or similar functionality, or guessing the logical path followed to get to the desired web page.

As described above, history 48 including the described representation 50 of accessed web pages may be implemented as an option which a user can selectively activate (e.g., display the history window and identifiers) or deactive (e.g., hide the history window and identifiers). Further, the representation 50 may be stored for future use and one or more identifier of the representation 50 may be selectively deleted. Aspects of the invention enable automatic establishment and storage of paths for accessing web pages which have been accessed (e.g., through different links).

According to exemplary embodiments and as mentioned above, processing circuitry 30 is configured to control operations of client device 26 to implement aspects of the invention. Processing circuitry 30 is configured to execute processor-usable or executable code stored within appropriate storage devices of device 26 or communicated to device 26 via an external network to implement aspects of the invention. For example, processor-usable code may be provided via articles of manufacture, such as an appropriate processor-usable medium comprising, for example, a floppy disk, hard disk, zip disk, CD-ROM, etc., or alternatively embodied within a transmission medium, such as a carrier wave, and communicated via a network, such as the Internet.

Referring to FIG. 7, an exemplary methodology performed by processing circuitry 30 according to executable code is illustrated. The illustrated method is presented to illustrate some aspects of the invention. Other methodologies are possible including more, less or alternative steps.

Initially at a step S10, the processing circuitry operates to forward a request to the Internet via a communication medium.

At a step S12, the processing circuitry monitors for the receipt of data, such as HTML or web page data, from the communication medium. Processing circuitry proceeds to a step S14 if the condition of step S12 is affirmative. Otherwise, the processing circuitry idles at step S12.

At step S14, processing circuitry controls the display of a web page or other image using the display device responsive to the received data.

At a step S16, the processing circuitry generates and adds an identifier corresponding to the web page or other image depicted in step S14 to a history.

At a step S18, it is determined whether the history is active, as selected by a user, for example. If the condition of step S18 is affirmative, the processing circuitry proceeds to a step S20.

At step S20, the processing circuitry is arranged to control the display device to display the identifier in the history according to the visual organizational representation.

The depicted methodology may end following the execution of step S20 or if the condition of step S18 is negative.

The protection sought is not to be limited to the disclosed embodiments, which are given by way of example only, but instead is to be limited only by the scope of the appended claims.

What is claimed is:

1. A client device comprising:
an interface adapted to communicate with a computer network including a plurality of web servers hosting a plurality of respective web sites and to receive web page data for a plurality of web pages from the web servers;
a display device configured to depict visually perceptible images; and
processing circuitry coupled with the display device and configured to control the display device to depict the web pages responsive to the received web page data and to depict a visual organizational representation of the web pages depicted using the display device, wherein the visual organizational representation comprises a plurality of first identifiers for selected ones of the web pages of one of the web sites and a plurality of second identifiers for selected others of the web pages of the one web site, and the first identifiers are depicted according to a first organizational scheme and the second identifiers are depicted according to a second organizational scheme visually distinguishable from the first identifiers of the first organizational scheme and one of the second identifiers is visually associated with one of the first identifiers.

2. The device of claim 1 wherein the processing circuitry is configured to control the display device to depict the first and the second organizational schemes comprising different spatial locations.

3. The device of claim 1 wherein the processing circuitry is configured to control the display device to depict the first and the second organizational schemes comprising different columns of respective ones of the first and the second identifiers.

4. The device of claim 1 wherein the processing circuitry is configured to control the display device to indent the second identifiers of the second organizational scheme with respect to the first identifiers of the first organizational scheme.

5. The device of claim 1 wherein the visual organizational representation comprises a navigation tree.

6. The device of claim 1 wherein the first identifiers comprise identifiers of a first type of web pages and the second identifiers comprise identifiers of a second type of web pages different than the first type of web pages.

7. The device of claim 6 wherein the first identifiers comprise identifiers of parent web pages and the second identifiers comprise identifiers of child web pages.

8. The device of claim 1 wherein the processing circuitry is configured to control the display device to depict the visual organizational representation comprising a history of the web pages depicted during a predefined period of time.

9. The device of claim 1 wherein the processing circuitry is configured to control the display device to depict the visual organizational representation responsive to received web page data and without user input.

10. The device of claim 1 wherein the processing circuitry is configured to depict the visual association comprising a path connector intermediate the one first identifier and the one second identifier.

11. The device of claim 1 wherein the processing circuitry is configured to execute code of a web browser to control the display device.

12. A processor-usable medium comprising:
processor-usable code configured to cause a processor to control a display of a plurality of web pages of a common web site and including a first type of the web pages and a second type of the web pages different than the first type of the web pages;
processor-usable code configured to cause a processor to control a display of a plurality of first identifiers corresponding to the first type of the web pages;
processor-usable code configured to cause a processor to control a display of a plurality of second identifiers corresponding to the second type of the web pages; and
processor-usable code configured to cause a processor to control a display of a visual association of one of the second identifiers with one of the first identifiers.

13. The medium of claim 12 further comprising processor-usable code configured to cause a processor to display a visual organizational representation comprising the first identifiers depicted according to a first organizational scheme and the second identifiers depicted according to a second organizational scheme visually distinguishable from the first identifiers of the first organizational scheme.

14. The medium of claim 12 wherein the visual organizational representation comprises a history of the web pages depicted during a predefined period of time.

15. The medium of claim 12 wherein the processor-usable code configured to cause the processor to control the display of the first and the second identifiers comprises processor-usable code configured to cause the processor to control the display of the first and the second identifiers within different columns.

16. The medium of claim 12 wherein the processor-usable code configured to cause the processor to control the display of the first and the second identifiers comprises processor-usable code configured to cause the processor to control the display of the second identifiers indented with respect to the first identifiers.

17. The medium of claim 12 wherein the processor-usable code configured to cause the processor to control the display of the first and the second identifiers comprises processor-usable code configured to cause the processor to control the display of the first and second identifiers within an navigation tree.

18. The medium of claim 12 wherein the first identifiers comprise identifiers of parent web pages and the second identifiers comprise identifiers of child web pages.

19. The medium of claim 12 wherein the processor-usable code configured to cause the processor to control the display of the first and the second identifiers comprises processor-usable code configured to cause the processor to control the display of the first and the second identifiers responsive to received web page data and without user input.

20. The medium of claim 12 wherein the processor-usable code configured to cause the processor to control the display of the visual association comprises processor usable code configured to cause the processor to control the display of a path connector intermediate the one first identifier and the one second identifier.

21. The medium of claim 12 wherein the processor-usable code comprises code of a web browser.

22. A processor-usable medium comprising:
processor-usable code configured to cause a processor to control a display of a plurality of web pages of a common web site and including a first type of the web pages and a second type of the web pages different than the first type of the web pages;
processor-usable code configured to cause a processor to control a display of a history including a plurality of first identifiers corresponding to the first type of the web pages and according to a first organizational scheme; and
processor-usable code configured to cause a processor to control a display of the history including a plurality of second identifiers corresponding to the second type of the web pages and according to a second organizational scheme visually distinguishable from the first identifiers displayed according to the first organizational scheme.

23. The medium of claim 22 further comprising processor-usable code configured to cause a processor to control a display of a visual association of one of the second identifiers with one of the first identifiers.

24. The medium of claim 22 wherein the processor-usable code configured to cause the processor to control the display of the first and the second identifiers comprises processor-usable code configured to cause the processor to control the display of the first and second identifiers within different columns.

25. The medium of claim 22 wherein the processor-usable code configured to cause the processor to control the display of the first and the second identifiers comprises processor-usable code configured to cause the processor to control the display of the second identifiers indented with respect to the first identifiers.

26. The medium of claim 22 wherein the processor-usable code configured to cause the processor to control the display of the first and the second identifiers comprises processor-usable code configured to cause the processor to control the display of the first and second identifiers within a navigation tree.

27. The medium of claim 22 wherein the first identifiers comprise identifiers of parent web pages and the second identifiers comprise identifiers of child web pages.

28. The medium of claim 22 wherein the processor-usable code configured to cause the processor to control the display of the first and the second identifiers comprises processor-usable code configured to control the display of the first and the second identifiers responsive to received web page data and without user input.

29. The medium of claim 22 wherein the processor-usable code comprises code of a web browser.

30. A data signal embodied in a transmission medium comprising:
processor-usable code configured to cause a processor to control a display of a plurality of web pages of a common web site and including a first type of the web pages and a second type of the web pages different than the first type of the web pages;
processor-usable code configured to cause a processor to control a display of a plurality of first identifiers corresponding to the first type of the web pages;
processor-usable code configured to cause a processor to control a display of a plurality of second identifiers corresponding to the second type of the web pages; and
processor-usable code configured to cause a processor to control a display of a visual association of one of the second identifiers with one of the first identifiers.

31. The signal of claim 30 further comprising processor-usable code configured to cause a processor to display a visual organizational representation comprising the first identifiers depicted according to a first organizational scheme and second identifiers depicted according to a second organizational scheme visually distinguishable from the first identifiers depicted according to the first organizational scheme.

32. A processor-implemented method of displaying a history of web pages depicted using a web browser, the method comprising:
providing web page data for a plurality of web pages of a common web site, the web pages including a first type of web pages and a second type of web pages different than the first type of the web pages;
depicting the first type and the second type of web pages of the common web site using a web browser;
depicting a plurality of first identifiers corresponding to the first type of the web pages within a history of the web browser;
depicting a plurality of second identifiers corresponding to the second type of the web pages within a history of the web browser; and
visually associating one of the second identifiers with one of the first identifiers.

33. The method of claim 32 wherein the depicting the first identifiers comprises depicting the first identifiers according to a first organizational scheme and the depicting the second identifiers comprises depicting the second identifiers according to a second organizational scheme visually distinguishable from the first identifiers depicted according to the first organizational scheme.

34. The method of claim 33 wherein the depicting the first and the second identifiers according to the first and second organizational schemes comprises depicting the first and the second identifiers within different spatial locations.

35. The method of claim 33 wherein the depicting the first and the second identifiers according to the first and second organizational schemes comprises depicting the first and the second identifiers within different columns.

36. The method of claim 33 wherein the depicting the first and the second identifiers according to the first and second organizational schemes comprises indenting the second identifiers with respect to the first identifiers.

37. The method of claim 32 wherein the depicting the first and the second identifiers comprises depicting the first and the second identifiers within a navigation tree.

38. The method of claim 32 wherein the depicting the first and the second identifiers comprises depicting corresponding to respective ones of parent web pages and child web pages.

39. The method of claim 32 wherein the depicting the first and the second identifiers comprises depicting within the history and corresponding to a predefined period of time.

40. The method of claim 32 wherein the depicting the first and the second identifiers comprises depicting responsive to the providing and without user input.

41. The method of claim 32 wherein the visually associating comprises depicting a path connector intermediate the one second identifier and the one first identifier.
